(19) United States
(12) Patent Application Publication
(10) Pub. No.: US 2024/0354921 A1
(43) Pub. Date: Oct. 24, 2024

(54) ROAD DEFECT LEVEL PREDICTION

(71) Applicant: NEC Laboratories America, Inc., Princeton, NJ (US)

(72) Inventors: Sparsh Garg, Fremont, CA (US); Bingbing Zhuang, Santa Clara, CA (US); Samuel Schulter, Long Island City, NY (US); Manmohan Chandraker, Santa Clara, CA (US)

(21) Appl. No.: 18/616,396

(22) Filed: Mar. 26, 2024

Related U.S. Application Data
(60) Provisional application No. 63/460,961, filed on Apr. 21, 2023.

(51) Int. Cl. G06T 7/00; G06T 7/10; G06T 7/50; G06V 20/56

(52) U.S. Cl. CPC G06T 7/0002; G06T 7/10; G06T 7/50; G06V 20/588; G06T 2207/10028; G06T 2207/20081; G06T 2207/20084; G06T 2207/30256

(57) ABSTRACT

Systems and methods for road defect level prediction. A depth map is obtained from an image dataset received from input peripherals by employing a vision transformer model. A plurality of semantic maps is obtained from the image dataset by employing a semantic segmentation model to give pixel-wise segmentation results of road scenes to detect road pixels. Regions of interest (ROI) are detected by utilizing the road pixels. Road defect levels are predicted by fitting the ROI and the depth map into a road surface model to generate road points classified into road defect levels. The predicted road defect levels are visualized on a road map.

### RELATED APPLICATION INFORMATION

This application claims priority to Provisional Application No. 63/460,961, filed on Apr. 21, 2023, incorporated herein by reference in its entirety.

### BACKGROUND

### Technical Field

The present invention relates to road analysis and, more particularly, to methods and systems for road defect level prediction.

### Description of the Related Art

Large road infrastructure maintenance budgets are allocated to enable road infrastructure entities to maintain road infrastructure. However, each road infrastructure is unique and is subjected to varying conditions such as traffic density, weather conditions, zoning, and traffic speed. These varying conditions degrade the road infrastructure in time, and the road defects they cause also vary in levels of severity. A road infrastructure maintenance team cannot prioritize maintaining road defects of a road without visiting and manually measuring the road. This method is costly and time-consuming for road infrastructure entities to implement on a larger scale to cover every road within its authority.

### SUMMARY

According to an aspect of the present invention, a computer-implemented method for road defect level prediction employing a processor device is presented. The computer-implemented method includes obtaining a depth map from image data received from input peripherals by employing a vision transformer model, obtaining a plurality of semantic maps from the image data by employing a semantic segmentation model to give pixel-wise segmentation results of road scenes to detect road pixels, detecting a region of interest (ROI) utilizing the road pixels, predicting road defect levels by fitting the ROI and the depth map into a road surface model to generate road points classified into road defect levels, and outputting the predicted road defect levels on a road map.

According to another aspect of the present invention, a non-transitory computer-readable storage medium including a computer-readable program for road defect level prediction is presented. The computer-readable program when executed on a computer causes the computer to perform obtaining a depth map from image data received from input peripherals by employing a vision transformer model, obtaining a plurality of semantic maps from the image data by employing a semantic segmentation model to give pixel-wise segmentation results of road scenes to detect road pixels, detecting a region of interest (ROI) utilizing the road pixels, predicting road defect levels by fitting the ROI and the depth map into a road surface model to generate road points classified into road defect levels, and outputting the predicted road defect levels on a road map.

According to another aspect of the present invention, a system for road defect level prediction is presented. The system includes a memory, and one or more processors in communication with the memory configured to obtain a depth map from image data received from input peripherals by employing a vision transformer model, obtain a plurality of semantic maps from the image data by employing a semantic segmentation model to give pixel-wise segmentation results of road scenes to detect road pixels, detect a region of interest (ROI) utilizing the road pixels, predict road defect levels by fitting the ROI and the depth map into a road surface model to generate road points classified into road defect levels, and output the predicted road defect levels on a road map.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a flow diagram illustrating a high-level overview of a computer-implemented method for road defect level prediction, in accordance with an embodiment of the present invention;

FIG. 2 is a flow diagram illustrating a method for obtaining a depth map by employing a vision transformer model, in accordance with an embodiment of the present invention;

FIG. 3 is a flow diagram illustrating a method for obtaining a plurality of semantic maps by employing a semantic segmentation model, in accordance with an embodiment of the present invention;

FIG. 4 is a flow diagram illustrating a method for detecting a region of interest (ROI) by utilizing the semantic maps obtained by employing a semantic segmentation model, in accordance with an embodiment of the present invention;

FIG. 5 is a flow diagram illustrating a method for fitting the depth map and the ROI into a road surface model, in accordance with an embodiment of the present invention;

FIG. 6 is a flow diagram illustrating a method for classifying the road points obtained using the road surface model into road defect levels, in accordance with an embodiment of the present invention;

FIG. 7 is a flow diagram illustrating a method for visualizing the classified points into a road map, in accordance with an embodiment of the present invention;

FIG. 8 is a block diagram illustrating a high-level overview of a computer system for road defect level prediction, in accordance with an embodiment of the present invention;

FIG. 9 is a block diagram illustrating a high-level overview of a system for road defect level prediction employing a vehicle that includes a computer system implementing the method for road defect level prediction, in accordance with an embodiment of the present invention; and

FIG. 10 is a block diagram illustrating a deep neural network that can be employed by the semantic segmentation model, the vision transformer model, and the road defect model, in accordance with an embodiment of the present invention.

### DETAILED DESCRIPTION OF PREFERRED EMBODIMENTS

In accordance with embodiments of the present invention, computer systems and computer-implemented methods are provided for road defect level prediction.

The present embodiments provide systems and computer-implemented methods for road defect level prediction that can employ a vision transformer model to obtain a depth map from an image dataset received from input peripherals. A segmentation model can be employed to obtain a plurality of semantic maps to give pixel-wise segmentation results of road scenes to detect road pixels. The road pixels are utilized to detect regions of interest (ROI). ROI and the depth map are fitted into a road surface model to generate road points. Road defect levels can be predicted by classifying road points into road defect levels relative to a road surface threshold. The output of the road defect level prediction method is a visualized road scene of the predicted road defect levels with the classified road points that can be shown in a map. In another embodiment, the visualized road scene with the classified road points can be uploaded to a server of an entity that maintains the road infrastructure.

Traditional methods of manually measuring road defect levels of a single road could take hours or days. Additionally, it could take weeks or months to measure a larger area of road infrastructure. However, road infrastructure degrades in time, and new road defects could form while the road infrastructure team measures the road defect levels.

In an embodiment, a vehicle can be employed having a computing device that can implement road defect level prediction. Doing so enables a road infrastructure team to efficiently predict road defect levels and upload their findings to a government entity or a map provider in seconds. Due to its efficiency and scalability, a road infrastructure team can quickly measure significantly larger areas of road infrastructure.

In another embodiment, the road scene is visualized with predicted road defect levels with colored points representing road defects. The visualized road scene with the predicted road defect levels can be uploaded to a database of an entity responsible for maintaining the road infrastructure. The entity can then monitor and determine the severity of the road infrastructure predicted to have road defects before the predicted road defect progresses into a road hazard by employing the computer-implemented method of road defect level prediction.

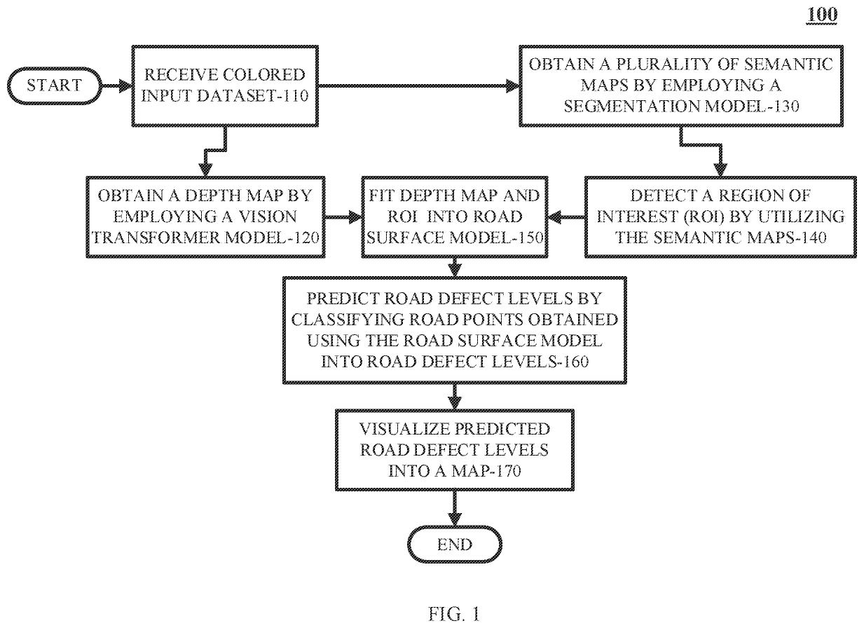

Referring now in detail to the figures in which like numerals represent the same or similar elements and initially to FIG. 1, a high-level overview of a computer-implemented method for road defect level prediction 100 is illustrated, in accordance with an embodiment of the present invention.

In an embodiment, image input data of a current road scene received from input peripherals can be utilized to generate a pseudo depth map by employing a vision transformer model. The image input data can also be utilized to generate a plurality of semantic maps by employing a semantic segmentation model. The pseudo depth map can be converted to a three-dimensional (3D) point cloud to obtain 3D points. The plurality of semantic maps can be employed to obtain regions of interest (ROI). The ROI and 3D points can be employed to calculate a road surface equation and road surface threshold. The road surface equation, road surface threshold, road pixels can be employed to calculate road points. The road points can be employed to predict road defect levels. The predicted road defect levels can be visualized onto a road map.

In block 110, image data of a current road scene can be received from one or more input peripherals.

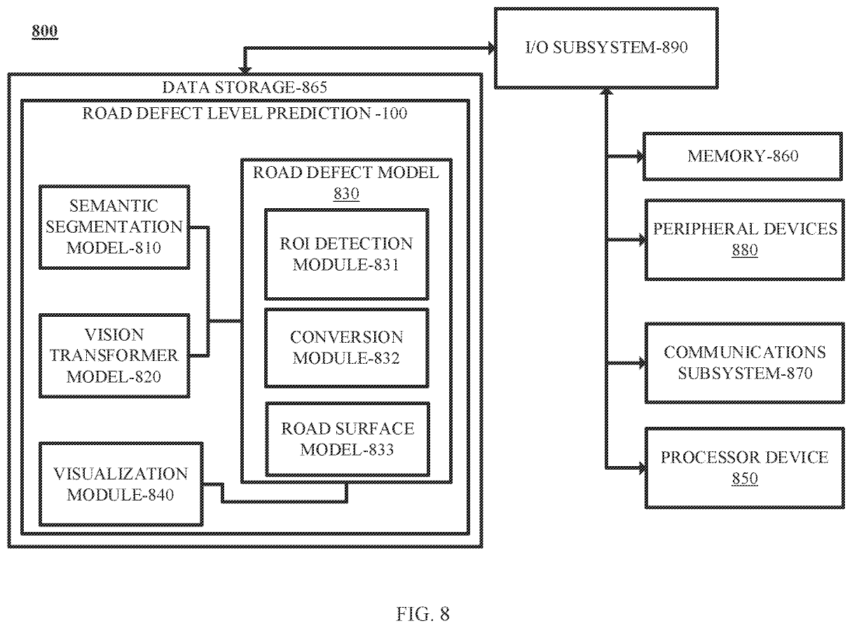

In block 120, a depth map can be obtained by employing a vision transformer model 820 (shown in FIG. 8). The vision transformer model can be pre-trained to generate a depth map which can then be converted into a 3D point cloud to estimate the road surface plane.

In block 130, a plurality of semantic maps can be obtained by employing a semantic segmentation model 810 (shown in FIG. 8). The semantic segmentation model can be pre-trained to generate a plurality of semantic maps that are pixel-wise representations of road scene categories and attributes.

In block 140, a plurality of regions of interest (ROI) can be detected by utilizing the semantic maps obtained by employing the semantic segmentation model 810. The semantic segmentation model can be employed again by the ROI detection module 831 (shown in FIG. 8) to detect ROI and determine whether the ROI is within the known object database of the ROI detection module 831.

In block 150, the depth map and ROI can be fitted into the road surface model 833 (shown in FIG. 8) to obtain road points. The depth map and ROI can then be employed to compute intersections between them relative to a calculated road surface plane equation. The road surface plane equation can be calculated by fitting the depth map and ROI into a road surface algorithm. The road surface threshold is calculated using the road surface plane equation and the road points.

In block 160, a road surface model 833 can be employed to predict road defect levels. The road defect levels are predicted based on road points relative to a road surface threshold.

In block 170, the predicted road defect levels can be visualized into a road map.

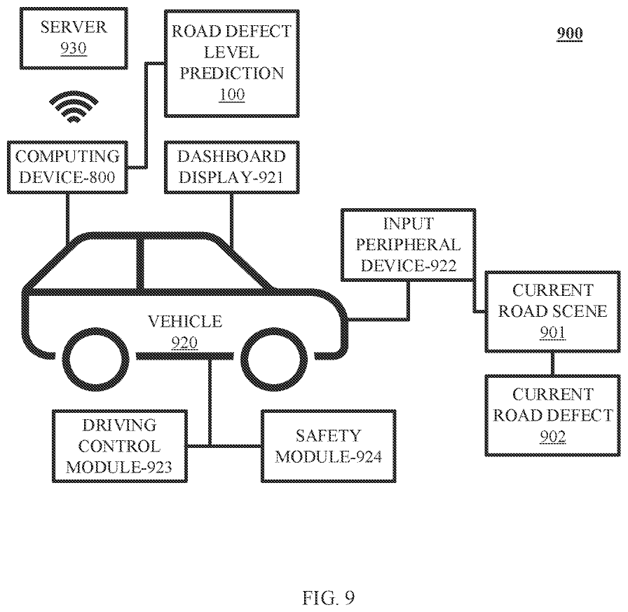

In another embodiment, the visualized map including the classified points can be uploaded to a server 930 (shown in FIG. 9).

In another embodiment, the predicted road defect levels can be employed to control the vehicle 920 (shown in FIG. 9) and avoid the predicted road defect.

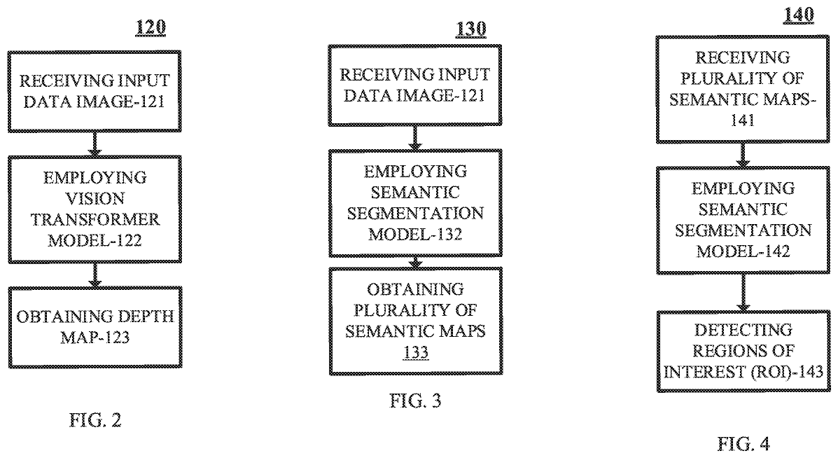

Referring now to FIG. 2, a flow diagram illustrating a method for obtaining a depth map by employing a vision transformer model 820 (shown in FIG. 8), in accordance with an embodiment of the present invention.

A depth map is an image that includes information relating to the distance of the surfaces of scene objects from a viewpoint (e.g., road surface, input peripheral). A darker color (e.g., more dense points) can represent a larger distance from the viewpoint and a lighter color (e.g., less dense points) can represent a smaller distance from the viewpoint. In block 121, input data image is received from the input peripherals.

In block 122, a vision transformer model 820 is employed to obtain a depth map.

In an embodiment, the road defect level prediction method can employ a vision transformer model 820 that is a monocular neural network-based model. The vision transformer model 820 can be a deep learning model that employs the mechanisms of attention, differentially weighing the significance of each part of the input sequence of image data. A Transformer architecture relies on self-attention mechanisms to transform a sequence of input embeddings of image data into a sequence of output embedding of image data without relying on convolutions or recurrent neural networks. A Transformer can be viewed as a stack of self-attention layers.

In an embodiment, a dense prediction transformation model (DPT) can be employed as the vision transformer model 820. A DPT is a type of vision transformer for dense prediction tasks (e.g., depth estimation). In an embodiment, the input image of the current road scene can be transformed into tokens by extracting non-overlapping patches followed by a linear projection of their flattened representation. In another embodiment, a feature extractor can be employed to obtain image embeddings. The image embedding is augmented with a positional embedding and a patch-independent readout token is added. The tokens are passed through multiple transformer stages. The tokens are reassembled from different stages into an image-like representation at multiple resolutions. Fusion modules progressively fuse and upsample the representations to generate a depth map (e.g., fine-grained prediction). The training dataset used to train DPT can be a mixed dataset (MIX6). Other training datasets are contemplated.

In block 123, the depth map can be obtained as the output of the vision transformer model 820 by utilizing the input image of the current road scene.

The depth map can be converted into a 3D point cloud to predict the road surface plane.

Referring now to FIG. 3, a flow diagram illustrating a method for obtaining a plurality of semantic maps by employing a semantic segmentation model, in accordance with an embodiment of the present invention.

A semantic map is a reconstruction of the original image in which each pixel has been color coded by its semantic class to create segmentation masks. A segmentation mask is a portion of the image that has been differentiated from other regions of the image.

In block 121, input image of the current road scene can be received from the input peripherals.

In block 132, in an embodiment, the road defect level prediction method can employ a semantic segmentation model 810 (shown in FIG. 8) to generate a plurality of semantic maps. A semantic segmentation model 810 can be employed to create a semantic map of an input image. Semantic segmentation models 810 can employ neural networks to group related pixels together into segmentation masks and correctly recognize road scene attributes and other categories for each group of pixels (e.g., segments).

In block 133, a plurality of semantic maps can be obtained as output of the semantic segmentation model 810 by employing the input image of the current road scene. The plurality of semantic map can include road scene attributes and other categories that can be employed as input by the road surface model. For example, road scene attributes and other categories that can be included in a semantic map are road type (e.g., highways, urban streets, rural roads, residential streets), lane markings (e.g., dashed lines, solid lines, bike lanes and paths, pedestrian crossings), traffic signs and signals (e.g., stop signs, traffic lights), roadside objects (e.g., barriers, buildings, trees, vehicles), traffic flow (e.g., direction of vehicle traffic), road surface condition, weather condition (e.g., snow, rain, dry), safety zones and hazardous areas (e.g., work zones, construction zones), road network connectivity (e.g., intersections, forks, roundabouts), and etc. Other categories are contemplated.

In an embodiment, a universal segmentation model can be employed as the semantic segmentation model 810. The universal segmentation model (UniSeg) segments images into semantic maps, regardless of the road scene. The universal segmentation model learns a wide range of road scene attributes and categories to generalize road scenes. UniSeg can unify all label spaces from multiple datasets and can train a single classifier.

To train the UniSeg, datasets are concatenated and pre-processed by resizing by scaling and random horizontal flipping. The datasets are combined using a simple concatenation operator. The backbone used is the high resolution network (HRNetV2) initialized with weights pre-trained on ImageNet. The models are trained using stochastic gradient descent with momentum and a polynomial learning rate decay scheme. The training data employed to train the UniSeg can be Cityscapes, Berkeley DeepDrive (BDD), India Driving Dataset (IDD), Mapillary. Other training datasets are contemplated.

Road pixels are pixels segmented together that are classified by the semantic segmentation model 810 as a road. Road distances are calculated based on the road pixels relative to a viewpoint (e.g., a camera input peripheral, bottom of the image input, or one segment).

Road pixels and road distances can be obtained as output by employing the semantic segmentation model 810. From these road pixels and road distances, the ROI can be detected.

Referring now to FIG. 4, a flow diagram illustrating a method for detecting a region of interest (ROI) by utilizing the plurality of semantic maps obtained by employing the semantic segmentation model, in accordance with an embodiment of the present invention.

In block 141, the plurality of semantic maps can be received for processing.

In block 142, a semantic segmentation model 810 (shown in FIG. 8) can be employed by a ROI detection module 831 (shown in FIG. 8) to detect ROI.

In an embodiment, the road defect model can include a ROI detection module 831. The ROI detection module 831 can employ the semantic segmentation model 810 (e.g., UniSeg) to detect the ROI from the plurality of semantic maps obtained from the semantic segmentation model 810.

In block 143, ROI can be detected. ROI can include the road and road defects. In an embodiment, road defects such as ruts and bumps can be identified as ROI. In another embodiment, undefined objects that are on the plane of the road can also be classified as a road defect. Known objects are road categories detected by the semantic segmentation model 810 and stored in the known object database of the ROI detection module 831. Examples of known objects are vehicles, trees, traffic signs, buildings, etc. Other known objects are contemplated. In contrast, segments that are directly on the plane of the road but are not classified within the known object database of the ROI detection module 831 are undefined objects.

The ROI and the depth map can then be employed to predict the road points.

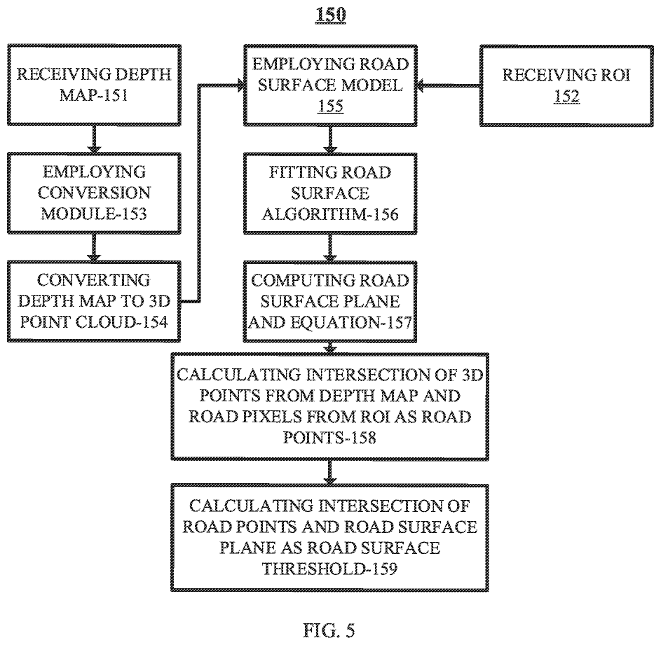

Referring now to FIG. 5, a flow diagram illustrating a method for fitting the depth map and the ROI into a road surface model, in accordance with an embodiment of the present invention.

In block 151, the depth map can be received for processing.

In block 152, the ROI can be received for processing.

In block 153, a conversion module 832 (shown in FIG. 8) can be employed to convert the depth map to a 3D point cloud. In an embodiment, the road defect model 830 (shown in FIG. 8) can include a conversion module that can convert the depth map into a 3D point cloud.

The depth map can be converted to a 3D point cloud to fit the depth map into a road surface model 833 (shown in FIG. 8). The resulting 3D points from the point cloud can be employed to generate the road surface plane equation by employing the road surface model 833.

In block 154, the depth map can be converted to a 3D point cloud. Converting the depth map into a 3D point cloud includes calibration, coordinate transformation and depth-to point conversion.

Calibration includes managing the input peripheral such as correcting for lens distortion or sensor irregularities.

Coordinate Transformation utilizes intrinsic parameters (e.g., focal length, principal point) of the input peripheral and the depth value at each pixel. In an embodiment, a projection model such as a pinhole camera model can be employed. In another embodiment, a computing device configured to run triangulation can be employed.

Depth-to-point conversion utilizes the following equations to calculate the 3D coordinates:

$$X = ( u - {C}_{x} ) \times \frac{z}{{f}_{x}} ; Y = ( v - {C}_{y} ) \times \frac{z}{{f}_{y}} ;$$

where (u,v) are pixel coordinates, (Cₓ, C_{y}) are the principal point coordinates, (fₓ, f_{y}) are the focal length, z is the depth value at the pixel.

In block 155, a road surface model 833 can be employed to predict the road surface threshold of a road scene by employing the 3D-point cloud converted from the depth map. The road defect model 830 can include the road surface model 833.

In block 156, the road surface model 833 can fit the 3D points from the depth map into a road surface algorithm to calculate a road surface plane equation. In an embodiment, the road surface algorithm can be random sample consensus (RANSAC) and the road surface plane equation can be a quadratic equation.

The road surface plane equations can be formulated as: ax²+bx+cy+d(x+y), where a, b, c, and d, are equation coefficients; and x and y are the x and y coordinates of the 3D points. The equation coefficients of the road surface plane equation can be different depending on the road type.

In block 157, the road surface plane and its corresponding equation can be computed by the road surface model 833. The road surface plane and its corresponding equation can be employed to compute the road surface threshold. The road surface plane is a representation of the plane on which the road surface exists.

In block 158, road points are calculated as intersections of 3D points and road pixels. The depth map and the ROI have intersecting 3D points and road pixels, respectively, which can be utilized to calculate the road points and the road surface threshold.

In an embodiment, the depth map and the ROI can be normalized and aligned to ensure that they have the same dimensions and coordinate system. Image transformations (e.g., scaling, rotating, translation) can be employed to align the depth map and the segment map having the ROI. Interpolation can be utilized to align the depth map and the segment map having the ROI. Affine interpolation can be utilized.

The intersections are computed based on a road distance from the viewpoint (e.g., camera input peripheral). For example, 20 feet of road distance from the viewpoint can be employed to calculate the road surface threshold. 3D points from the depth map and road pixels from the ROI within 20 feet from the viewpoint can be filtered and employed to calculate the road surface threshold.

Road points are the intersecting road pixels from both the 3D point cloud converted from the depth cloud and the ROI within the distance (e.g., 20 feet).

In block 159, the road surface threshold can be calculated. The road surface threshold is the intersection of road points and the road surface plane obtained from the depth map.

The calculated road points can be predicted into road defect levels by employing the road surface threshold.

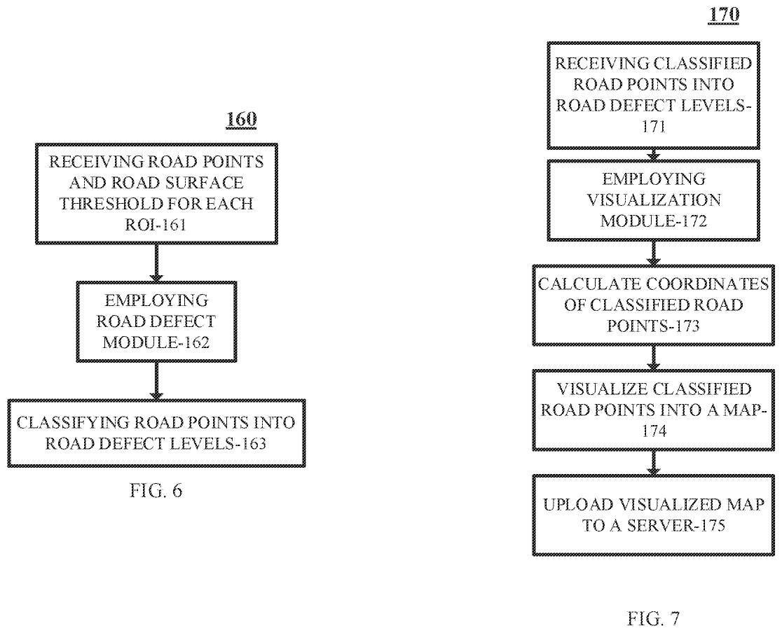

Referring now to FIG. 6, a flow diagram illustrating a method for classifying the road points obtained using the road surface model 833 (shown in FIG. 8) into road defect levels, in accordance with an embodiment of the present invention.

In block 161, road points and the road surface threshold for each ROI can be received for processing.

In block 162, a road defect model 830 (shown in FIG. 8) can be employed to predict road points into road defect levels.

In block 163, road points are predicted into road defect levels. Road points are predicted depending on the position of the road points relative to the road surface threshold. In an embodiment, for example, the road points that are below the road surface threshold are predicted as ruts. The road points that are above the road surface threshold are predicted as bumps. Road points are below or above the road surface threshold relative to a coordinate plane where the x-axis is the road surface threshold.

In another embodiment, road defects can also be classified as potholes, cracks, and edge failure depending on the positions of the road points relative to the road surface threshold. Other road defects are contemplated.

The distance of the road points from the road surface threshold can be estimated by the road defect model 830. The road points are then predicted into road defect levels depending on the severity of their differences relative to the road surface threshold. For example, for a road point that has a difference of 4 centimeters (cm.) or more can be predicted as severe; a road point that has a difference of 2-4 cm. can be predicted as moderate, and a road point that has a difference of 0-2 cm. can be predicted as mild.

In an embodiment, a different color can represent different road defects and color intensities can represent road defect level. For example, a road point predicted as a severe rut can be colored dark red (e.g., hex code #990000); a road point predicted as a moderate rut can be red (e.g., hex code #cc0000); a road point predicted as a mild rut can be light red (e.g., hex code #e06666).

In another embodiment, a different color can represent different road defects and road defect levels. For example, a road point predicted as a severe rut can be colored dark red (e.g., hex code #990000); a road point predicted as a moderate rut can be yellow (e.g., hex code #edd000); a road point predicted as a mild rut can be yellow green (e.g., hex code #95c11f); and a road point predicted as a mild bump can be light blue (e.g., hex code #6fa8dc).

In an embodiment, the road scene representation with colored points representing road defects and road defect levels can be utilized to visualize the predicted road defects into a road map.

Referring now to FIG. 7, a flow diagram illustrating a method for visualizing the predicted road points into a road map, in accordance with an embodiment of the present invention.

In block 171, predicted road defect levels including road points are received for processing.

In block 172, a visualization module 840 (shown in FIG. 8) can be employed to visualize predicted road points into a road map.

The computer-implemented method for road defect level prediction can be implemented in a vehicle 920 (shown in FIG. 9).

In block 173, the coordinates of the predicted road points can be calculated by the visualization module 840. To visualize the road scene including the predicted road defects, the GPS coordinates of the image data input can be obtained. In an embodiment, the coordinates of the road defect can be predicted by employing the intrinsic properties of the input peripheral (e.g., camera) that took the image data set which can be previously geotagged to include GPS coordinates, and the road points of the road defect. A bounding box of the predicted road defect can also be calculated by utilizing the road points of the road defect on the road surface plane.

In an embodiment, an object detection model can be employed to calculate the coordinates of the predicted road defects. Object detection models such as Faster region-based convolutional neural network (R-CNN), you only look once (YOLO), single shot multibox detector (SSD), and Mask R-CNN can be employed.

In block 174, the predicted road points can be visualized into a road map. The road map is a visualization of the road scene where coordinates of road objects can be updated and tagging the coordinates as a road defect. In an embodiment, predicted coordinates of the current road defects 902 (shown in FIG. 9) can be shown to a road map employed by a vehicle 920 to simulate current road scenes 901 (shown in FIG. 9) and to show navigation details to a user. For example, route trajectories can be shown on a display on the dashboard of a vehicle 920 in which current road scenes 901 can be simulated in real time. The current road defects 902 can also be shown with the route trajectories on the same display.

In block 175, the visualized road map can be uploaded to a server 930 (shown in FIG. 9). In an embodiment, calculated coordinates of the predicted road defects can be uploaded to the server 930. For example, a route navigation provider can have a server that is utilized to show navigation details to a computing device (e.g., dashboard display of a vehicle, mobile device). The navigation details can include route directions, route trajectories, route estimation, traffic density estimation based on the route.

In another embodiment, the road scene representation with colored points representing road defects and road defect levels can be uploaded to a database of an entity responsible for maintaining the road infrastructure. The entity can then monitor and determine the severity of the road infrastructure predicted to have road defects before the predicted road defect progresses into a road hazard by employing the road scene representation.

Referring now to FIG. 8, a block diagram illustrating a high-level system for road defect level prediction as implemented in a computer system 800, in accordance with an embodiment of the present invention.

The computing device 800 illustratively includes the processor device 850, an input/output subsystem 890, a memory 860, a data storage device 865, and a communication subsystem 870, and/or other components and devices commonly found in a server or similar computing device. The computing device 800 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 860, or portions thereof, may be incorporated in the processor device 850 in some embodiments.

The processor device 850 may be embodied as any type of processor capable of performing the functions described herein. The processor device 850 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 860 may be embodied as any type of volatile or non-volatile memory or data storage capable of performing the functions described herein. In operation, the memory 860 may store various data and software employed during operation of the computing device 800, such as operating systems, applications, programs, libraries, and drivers. The memory 860 is communicatively coupled to the processor device 850 via the I/O subsystem 890, which may be embodied as circuitry and/or components to facilitate input/output operations with the processor device 850, the memory 860, and other components of the computing device 800. For example, the I/O subsystem 890 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 890 may form a portion of a system-on-a-chip (SOC) and be incorporated, along with the processor device 850, the memory 860, and other components of the computing device 800, on a single integrated circuit chip.

The data storage device 865 may be embodied as any type of device or devices configured for short-term or long-term storage of data such as, for example, memory devices and circuits, memory cards, hard disk drives, solid state drives, or other data storage devices. The data storage device 865 can store program code for road defect level prediction 100, including the semantic segmentation model 810, the vision transformer model 820, the road defect model 830, the ROI detection module 831, the conversion module 832, the road surface model 833, and/or the visualization module 840. Any or all of these program code blocks may be included in a given computing system. The communication subsystem 870 of the computing device 800 may be embodied as any network interface controller or other communication circuit, device, or collection thereof, capable of enabling communications between the computing device 800 and other remote devices over a network. The communication subsystem 870 may be configured to employ any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 800 may also include one or more peripheral devices 880. The peripheral devices 880 may include any number of additional input/output devices, interface devices, and/or other peripheral devices. For example, in some embodiments, the peripheral devices 880 may include a display, touch screen, graphics circuitry, keyboard, mouse, speaker system, microphone, network interface, and/or other input/output devices, interface devices, GPS, camera, and/or other peripheral devices.

Of course, the computing device 800 may also include other elements (not shown), as readily contemplated by one of skill in the art, as well as omit certain elements. For example, various other sensors, input devices, and/or output devices can be included in computing device 800, depending upon the particular implementation of the same, as readily understood by one of ordinary skill in the art. For example, various types of wireless and/or wired input and/or output devices can be employed. Moreover, additional processors, controllers, memories, and so forth, in various configurations can also be utilized. These and other variations of the processing system 800 are readily contemplated by one of ordinary skill in the art given the teachings of the present invention provided herein.

Referring now to FIG. 9, a block diagram illustrating a high-level system for road defect level prediction 900 as implemented in a vehicle 920 that includes a computing device 800 implementing the method for road defect level prediction 100, in accordance with an embodiment of the present invention.

FIG. 9 includes a current road scene 901, vehicle 920 implementing the present embodiments, and a server 930.

The vehicle 920 can include a dashboard display 921, input peripheral device 922 (e.g., camera), computing device 800 implementing the method for road defect level prediction 100, safety module 924, and a driving control module 923.

In an embodiment, the driving control module 923 can include vehicle driving control mechanisms such as steering controls and braking. The safety module 924 can detect safe driving conditions (e.g., ample space around the vehicle 920, clear lanes, ample braking space, etc.).

The computing device 800 implementing the present embodiments can automatically predict road defect level in seconds just by capturing image data when approaching the estimated road point coordinates. Upon estimating the road defect level, the computing device implementing the present embodiments can upload the output of the present embodiments (e.g., visualized map, coordinates of the road defect level, road defect level) to a server 930. The server 930 can be a server utilized by the road infrastructure team of a government entity or the server utilized by the map provider. The server 930 can also be a server utilized by a private entity to monitor road defect levels in road infrastructures. By uploading the predicted road defect levels to a server 930, the coordinates of the predicted road defects can be broadcast to other vehicles 920.

The dashboard display 921 can be integrated into the dashboard of the vehicle 920 or can be a separate computing device (e.g., mobile phone, portable head unit, etc.) to show navigation through a route navigation provider. The route navigation provider can be integrated into the vehicle 920 (e.g., provided by the vehicle manufacturer) or a separate route navigation provider (e.g., provided by entities other than the vehicle manufacturer). The route navigation provider can send updated route trajectories to avoid traffic caused by the road defect.

In an embodiment, the input peripheral device 922 can be mounted in front of the vehicle 920. In another embodiment, the input peripheral device 922 can be mounted on top of the vehicle. Other mounting points are contemplated.

In another embodiment, upon estimating the road defect level, the driving control module 923 of the vehicle 920 can automatically control the vehicle 920 to avoid the current road defect 902 depending on the road defect level, and road traffic conditions. For example, if the safety module 923 of the vehicle 920 detects that it is safe to change the direction of the vehicle 920 (e.g., there is ample space around the vehicle 920 and the lanes are clear) and the road defect level is moderate to high, the driving control module 923 can change the direction of the vehicle 920 to avoid the road defect. Additionally, if the safety module 924 of the vehicle 920 detects that it is safe to slow down the vehicle 920 (e.g., there is ample space in front and in the back of the vehicle 920) and the road defect level is moderate to high, the driving control module 923 can control the brakes of the vehicle 920 to slow the vehicle 920 to safe speeds (e.g., less than 20 miles per hour) to prevent damage to the vehicle 920.

The current road scene 901 is the road scene perceived by the vehicle 920 in real-time can include the current road defect 902.

In an embodiment, multiple vehicles 920 can be employed to implement the computer-implemented method for road defect level prediction 100 to concurrently monitor and predict road defect levels of multiple road infrastructures. Thus, enabling efficient, scalable, and significantly faster measuring and monitoring of road defect levels of a wide range of road infrastructure.

Other practical applications of the present embodiments are contemplated.

A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers.

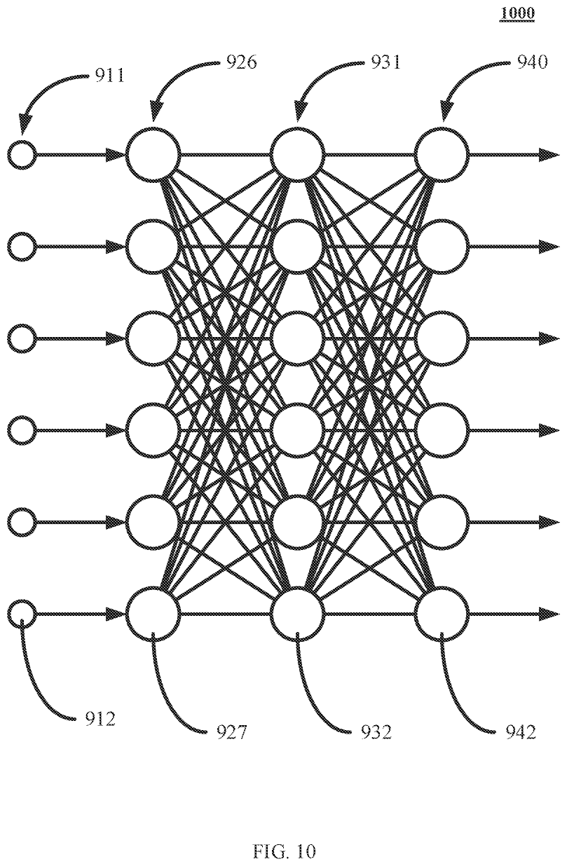

In FIG. 10, a deep neural network is shown. The vision transformer model 820, semantic segmentation model 810, and road defect model 830 can be deep neural networks. The deep neural network 1000, such as a multilayer perceptron, can have an input layer 911 of source nodes 912, one or more computation layer(s) 926 having one or more computation nodes 932, and an output layer 940, where there is a single output node 942 for each possible category into which the input example could be classified. An input layer 911 can have a number of source nodes 912 equal to the number of data values 912 in the input data 911. The computation nodes 932 in the computation layer(s) 926 can also be referred to as hidden layers, because they are between the source nodes 912 and output node(s) 942 and are not directly observed. Each node 932, 942 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 932 in the one or more computation (hidden) layer(s) 926 perform a nonlinear transformation on the input data 912 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for road defect level prediction employing a processor device comprising:
obtaining a depth map from an image data received from input peripherals by employing a vision transformer model;
obtaining a plurality of semantic maps from the image data by employing a semantic segmentation model to give pixel-wise segmentation results of road scenes to detect road pixels;
detecting a region of interest (ROI) utilizing the road pixels;
predicting road defect levels by fitting the ROI and the depth map into a road surface model; and
outputting the predicted road defect levels on a road map.

2. The computer-implemented method of claim 1, wherein the vision transformer model is a dense prediction transformation model (DPT).

3. The computer-implemented method of claim 1, wherein the semantic segmentation model is a Universal Segmentation (UniSeg) model.

4. The computer-implemented method of claim 1, wherein the ROI is selected by employing a ROI detection module based on the road pixels and road distances obtained by utilizing the semantic segmentation model.

5. The computer-implemented method of claim 1, wherein the road surface model predicts road defect levels by calculating a severity of differences of road points that are beyond a road surface threshold.

6. The computer-implemented method of claim 5, wherein the road surface model utilizes the depth map and the ROI to filter road points up to a certain distance to determine the road defect level above or below the road surface threshold.

7. The computer-implemented method of claim 1, wherein the depth map obtained from the image data is converted to a three-dimensional point cloud to calculate a road surface plane equation.

8. The computer-implemented method of claim 3, wherein the semantic segmentation model generates semantic maps that include road scene attributes and road categories that are employed to select the ROI.

9. A non-transitory computer-readable storage medium comprising a computer-readable program for road defect level prediction wherein the computer-readable program when executed on a computer causes the computer to perform:
obtaining a depth map from an image data received from input peripherals by employing a vision transformer model;
obtaining a plurality of semantic maps from the image data by employing a semantic segmentation model to give pixel-wise segmentation results of road scenes to detect road pixels;
detecting a region of interest (ROI) utilizing the road pixels;
predicting road defect levels by fitting the ROI and the depth map into a road surface model; and
outputting the predicted road defect levels on a road map.

10. The non-transitory computer-readable storage medium of claim 9, wherein the vision transformer model is a dense prediction transformation model (DPT).

11. The non-transitory computer-readable storage medium of claim 9, wherein the semantic segmentation model is a Universal Segmentation model.

12. The non-transitory computer-readable storage medium of claim 9, wherein the ROI is selected by employing a ROI detection module based on the road pixels and road distances obtained by utilizing the semantic segmentation model.

13. The non-transitory computer-readable storage medium of claim 9, wherein the road surface model predicts road defect levels by calculating a severity of differences of road points that are beyond a road surface threshold.

14. The non-transitory computer-readable storage medium of claim 13, wherein the road surface model utilizes the depth map and the ROI to filter road points up to a certain distance to determine the road defect level above or below the road surface threshold.

15. The non-transitory computer-readable storage medium of claim 9, wherein the depth map obtained from the image data is converted to a three-dimensional point cloud to calculate a road surface plane equation.

16. The non-transitory computer-readable storage medium of claim 12, wherein the semantic segmentation model generates semantic maps that includes road scene attributes and road categories that are employed to select the ROI.

17. A system for road defect level prediction, the system comprising:
a memory; and
one or more processors in communication with the memory configured to:
obtain a depth map from an image data from an image dataset received from input peripherals by employing a vision transformer model;
obtain a plurality of semantic maps from the image data by employing a semantic segmentation model to give pixel-wise segmentation results of road scenes to detect road pixels;
detect a region of interest (ROI) utilizing the road pixels;
predict road defect levels by fitting the ROI and the depth map into a road surface model; and
output the predicted road defect levels on a road map.

18. The system for road defect level prediction of claim 17, wherein the input peripherals are mounted on a vehicle.

19. The system for road defect level prediction of claim 17, wherein coordinates of the predicted road defect levels are broadcast to other vehicles when a vehicle implementing the system for road defect level prediction approaches the coordinates.

20. The system for road defect level prediction of claim 17, wherein the road surface model predicts road defect levels by calculating a severity of differences of road points that are beyond a road surface threshold.
